(19) United States
(12) Patent Application Publication
(10) Pub. No.: US 2004/0248013 A1
(43) Pub. Date: Dec. 9, 2004

(54) Organic-inorganic hybrid proton-conductive membrane, and fuel cell

(75) Inventors: Koji Wariishi, Minami-ashigara-shi (JP); Michio Ono, Minami-ashigara-shi (JP)

Correspondence Address: G. Peter Nichols, Brinks Hofer Gilson & Lione, P.O. Box 10395, Chicago, IL, 60610, US

(73) Assignee: Fuji Photo Film Co., Ltd.

(21) Appl. No.: 10/806,258

(22) Filed: Mar. 22, 2004

(30) Foreign Application Priority Data
Mar. 25, 2003 (JP) 082371/2003

(51) Int. Cl. H01M 6/18; H01M 8/10

(52) U.S. Cl. 429/313; 429/30; 429/33

(57) ABSTRACT

Disclosed is a proton-conductive membrane having a structure with a group that contains an organic molecular chain and a proton-donating group being covalent-bonded to a silicon-oxygen three-dimensional crosslinked matrix therein, which contains a partial structure represented by the formula (1) defined in the specification and a partial structure represented by the formula (2) defined in the specification.

### BACKGROUND OF THE INVENTION

1. Technical Field

The present invention relates to an organic-inorganic hybrid proton-conductive membrane that is utilized in energy devices, electrochemical sensors, display devices and others, and to a solid polymer fuel cell that comprises the membrane.

2. Background Art

These days it is expected that solid polymer fuel cells will be put into practical use for, for example, power sources for household use and power sources to be mount on vehicles as clean power-generating devices that are ecological to the global environment. The main stream of such solid polymer fuel cells is toward those that require hydrogen and oxygen as the fuel thereof. Recently, a direct methanol fuel cell (DMFC) has been proposed, in which methanol is used in place of hydrogen for fuel. This is expected to give high-capacity batteries for mobile devices that are substitutable for lithium secondary batteries, and is now much studied in the art.

The important functions of the electrolytic membrane (proton-conductive membrane) for solid polymer fuel cells are to physically insulate the fuel (e.g., hydrogen, aqueous methanol solution, etc.) fed to the anode, catalyst electrode from the oxidizing gas (e.g., oxygen) fed to the cathode, to electrically insulate the anode from the cathode, and to transmit the proton having been formed on the anode to the cathode. To fulfill these functions, the electrolytic membrane must have some mechanical strength and proton conductivity.

In the electrolytic membrane for solid polymer fuel cells, generally used is a sulfonic acid group-having perfluorocarbon polymer such as typically Nafion®. The electrolytic membrane of the type has good ionic conductivity and has relatively high mechanical strength, but has some problems to be solved such as those mentioned below. Concretely, in the electrolytic membrane, water and the sulfonic acid group contained in the membrane form cluster channels, and protons move in the cluster channels via water therein. Therefore, the ionic conductivity significantly depends on the water content thereof that is associated with the humidity in the service environment in which the cells are driven. For poisoning reduction in the catalyst electrode with CO and for activation of the catalyst electrode therein, solid polymer fuel cells are preferably driven at a temperature falling within a range of from 100 to 150° C. However, within such a middle-temperature range, the water content of the electrolytic membrane in the cells lowers with the reduction in the ionic conductivity thereof, and it causes a problem in that the expected cell characteristics could not be obtained. In addition, the softening point of the electrolytic membrane is around 120° C. and when the cells are driven at a temperature around it, then still another problem with it is that the mechanical strength of the electrolytic membrane is unsatisfactory. On the other hand, when the electrolytic membrane of the type is used in DMFC, then it causes still other problems such as those mentioned below. Naturally, the membrane readily absorbs water and its barrier ability against the fuel methanol is not good. Therefore, methanol having been fed to the anode penetrates through the electrolytic membrane to reach the cathode. Owing to it, the cell output power lowers, and this is referred to as a methanol-crossover phenomenon, and is a serious problem. For practical use of DMFC, this is one important problem to be solved.

Given that situation, there is a growing tendency for the development of other proton-conductive membranes substitutable for Nafion®, and some hopeful electrolytic materials have been proposed. For inorganic proton-conductive materials, for example, known are proton-conductive gasses such as those described in Journal of Physical Chemistry, B, 1999, Vol. 103, p. 9468; Physical Review, B, 1997, Vol. 55, p. 12108; and JP-A 2000-272932, 2000-256007, 2000-357524, 2001-93543. These are obtained through polymerization of tetraalkoxysilane in the presence of acid in a sol-gel process, and it is known that their humidity dependency is low in a high-temperature range. However, they are not flexible and are extremely brittle, and large-area membranes are difficult to produce from them. Therefore, the materials are unsuitable for electrolytes for fuel cells.

Now, a proton-conductive material has been proposed, which is prepared by introducing an organic component for flexibility into a siloxane network formed through sol-gel reaction of an organosilicon compound as a precursor in the presence of a proton acid, followed by adding a proton donor (e.g., phosphoric acid, or heteropoly-acid such as tungstophosphoric acid, tungstosilicic acid) to the resulting organic-inorganic nanohybrid material, and which has therefore solved the brittleness of glass (for example, see Japanese Patent 3,103,888 (pp. 4-7); Electrochimica Acta, 1998, Vols. 10-11, No. 43, p. 1301; and Industrial Materials (by Nikkan Kogyo Shinbun-sha, 2002, Vol. 50, p. 39). However, the organic-inorganic hybrid proton-conductive material of the type is problematic in that, when it is dipped in a methanol-water solution that is applied thereto as fuel, then the added proton donor dissolves out into the fuel and therefore dissolves out of the conductive membrane. In addition, an organic-inorganic hybrid material has been proposed, in which a proton donor, sulfo group is covalent-bonded and fixed to the siloxane network (for example, see German Patent DE 10061920A1; and Solid State Ionics, 2001, No. 145, p. 127). However, the material of the type is generally not flexible and is extremely brittle, and films are difficult to product from it. In addition, these references do not have a good description relating to the methanol perviousness of the material that is an extremely important characteristic thereof for use in DMFC.

An object of the present invention is to provide a proton-conductive membrane from which the proton donor dissolves out little and of which the methanol perviousness is low favorably for DMFC, and to provide a fuel cell that comprise the membrane.

### SUMMARY OF THE INVENTION

Taking the matters mentioned above into consideration, we, the present inventors have assiduously studied and, as a result, have found that, when an organic compound having both a polymerizable group and a hydrolyzable silicon-alkoxide group as substituents introduced thereinto, and an organic compound having a proton-donating group or its precursor as a substituent introduced thereinto are used as precursor for sol-gel reaction and when the compounds are reacted through hydrolysis and polycondensation in a sol-gel process, then an organic-inorganic hybrid membrane of good flexibility is obtained in which the proton donor is well fixed and of which the methanol perviousness is low. On the basis of this finding, we have reached the present invention.

Specifically, the proton-conductive membrane of the invention has a structure with a group that contains an organic molecular chain and a proton-donating group being covalent-bonded to the silicon-oxygen three-dimensional crosslinked matrix therein, and is characterized in that it contains a partial structure represented by the following formula (1):

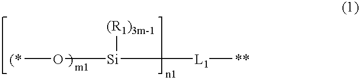

wherein R₁ represents an alkyl group or an aryl group; L₁ represents an (n1+1)-valent linking group; m1 represents an integer of from 1 to 3; n1 represents an integer of from 1 to 4; * indicates the position at which the group bonds to the silicon atom; and ** indicates the position at which the group bonds to an organic polymer chain,

and a partial structure represented by the following formula (2):

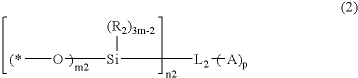

wherein R₂ represents an alkyl group or an aryl group; L₂ represents an (n2+p)-valent linking group; A represents a proton-donating group; m2 represents an integer of from 1 to 3; n2 represents an integer of from 1 to 4; p represents an integer of from 1 to 3; * indicates the position at which the group bonds to the silicon atom.

Preferably, the partial structure represented by the formula (1) is formed through sol-gel reaction of an organosilicon compound as a precursor represented by the following formula (3):

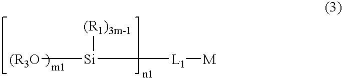

wherein R₁ represents an alkyl group or an aryl group; R₃ represents a hydrogen atom, an alkyl group, an aryl group or a silyl group; L₁ represents an (n1+1)-valent linking group; M represents a polymerizable group that may form a carbon-carbon bond or a carbon-oxygen bond through polymerization; m1 represents an integer of from 1 to 3; n1 represents an integer of from 1 to 4; and when m1 is 2 or more, then R₃'s may be the same or different.

Also preferably, the partial structure represented by the formula (2) is formed through sol-gel reaction of an organosilicon compound as a precursor represented by the following formula (4):

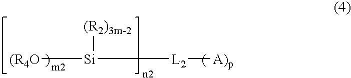

wherein R₂ represents an alkyl group or an aryl group; R₄ represents a hydrogen atom, an alkyl group, an aryl group or a silyl group; L₂ represents an (n2+p)-valent linking group; A represents a proton-donating group; m2 represents an integer of from 1 to 3; n2 represents an integer of from 1 to 4; p represents an integer of from 1 to 3; and when m2 is 2 or more, then R₄'s may be the same or different.

Also preferably, the partial structure represented by the formula (2) is formed of a sulfonic acid sol prepared through oxidation of a solution that contains an organosilicon compound represented by the following formula (5) and/or formula (6):

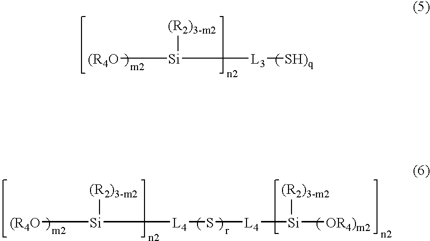

wherein R₂ represents an alkyl group or an aryl group; R₄ represents a hydrogen atom, an alkyl group, an aryl group or a silyl group; L₃ represents an (n2+q)-valent linking group; L₄ represents an (n2+1)-valent linking group; m2 represents an integer of from 1 to 3; n2 represents an integer of from 1 to 4; q represents an integer of from 1 to 3; r represents an integer of from 2 to 5; and when m2 is 2 or more, then R₄'s may be the same or different.

The proton-conductive membrane of the invention has better properties when it satisfies the following conditions:

(1) Preferably, R₁ is an alkyl group having from 1 to 10 carbon atoms.

(2) Preferably, L₁ represents an alkylene group, an arylene group, —O—, or a linking group formed by combining two or more of these.

(3) Preferably, m1 is 2 or 3.

(4) Preferably, n1 is 1.

(5) Preferably, R₂ is an alkyl group having from 1 to 10 carbon atoms.

(6) Preferably, L₂ is an alkylene group, an arylene group, or a linking group formed by combining two or more of these.

(7) Preferably, m2 is 2 or 3.

(8) Preferably, n2 is 1.

(9) Preferably, R₃ is an alkyl group having from 1 to 10 carbon atoms.

(10) preferably, M is an ethylenic unsaturated residue, an epoxy group, or an oxetanyl group.

(11) Preferably, R₄ is an alkyl group having from 1 to 10 carbon atoms.

(12) Preferably, the oxidizing agent is soluble in water.

(13) Preferably, the oxidizing agent is hydrogen peroxide or peracetic acid.

The proton-conductive membrane of the invention is favorable for membrane electrode assemblies and electrolytic membranes for fuel cells.

### BRIEF DESCRIPTION OF THE DRAWINGS

FIG. 1 is a schematic cross-sectional view showing the constitution of a membrane electrode assembly that comprises the proton-conductive membrane of the invention.

FIG. 2 is a schematic cross-sectional view showing one example of the constitution of the fuel cell of the invention.

In the drawings, 10 is a membrane electrode assembly (MEA); 11 is a proton-conductive membrane; 12 is an anode; 12a is an anode porous conductive sheet; 12b is an anode catalyst layer; 13 is a cathode; 13a is a cathode porous conductive sheet; 13b is a cathode catalyst layer; 14 is a gasket; 15 is an anode-side opening; 16 is a cathode-side opening; 17 is a collector; and 21 and 22 are separators.

### BEST MODES OF CARRYING OUT THE INVENTION

[1] Polymerizable Group-having Organosilicon Compound, and Sulfonic Acid Group-having Precursor:

[1-1] Polymerizable Group-having Silicon Compound:

The organic-inorganic hybrid proton-conductive membrane of the invention is formed of a silicon-oxygen three-dimensional crosslinked polymer that has a partial structure represented by the formula (1) and a partial structure represented by the formula (2), for which the polymer is prepared through sol-gel reaction of a compound having both a polymerizable group and a hydrolyzable silicon-alkoxide group as substituents introduced thereinto, and a compound having a proton-donating group or its precursor as a substituent introduced thereinto as precursors. The sol-gel reaction as referred to herein is described in detail, for example, in Sumio Sakuhana's Science of Sol-Gel Process (by Agne-Shofu sha).

Preferably, the precursor to form the partial structure of the formula (1) is a compound of the formula (3):

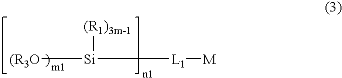

In the formula (3), R₁ represents an alkyl group or an aryl group; R₃ represents a hydrogen atom, an alkyl group, an aryl group or a silyl group. Preferred examples of the alkyl group represented by R₁ and R₃ are linear, branched or cyclic alkyl groups (for example, alkyl groups each having from 1 to 20 carbon atoms, such as methyl, ethyl, isopropyl, n-butyl, 2-ethylhexyl, n-decyl, cyclopropyl, cyclohexyl, cyclododecyl, etc.). Preferred examples of the aryl group represented by R₁ and R₃ are substituted or unsubstituted phenyl and naphthyl groups, etc. each having from 6 to 20 carbon atoms. Preferred examples of the silyl group represented by R₃ are silyl groups substituted with three alkyl groups selected from alkyl groups each having from 1 to 10 carbon atoms (e.g., trimethylsilyl, triethylsilyl, triisopropylsilyl, etc.), or polysiloxane groups (e.g., —(Me₂SiO)ₙH where n=10 to 100, etc.). R₁ and R₃ may be further substituted by substituents, for which preferred substituents are the groups mentioned below.

1. Alkyl Group:

The alkyl group may be optionally substituted, and is more preferably an alkyl group having from 1 to 24 carbon atoms, even more preferably from 1 to 10 carbon atoms. It may be linear or branched. For example, it includes methyl, ethyl, propyl, butyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl and octylcyclohexyl groups, etc.

2. Aryl Group:

The aryl group may be optionally substituted and condensed, and is more preferably an aryl group having from 6 to 24 carbon atoms. For example, it includes phenyl, 4-methylphenyl, 3-cyanophenyl, 2-chlorophenyl and 2-naphthyl groups, etc.

3. Heterocyclic Group:

The heterocyclic group may be optionally substituted and condensed. When it is a nitrogen-containing heterocyclic group, the nitrogen atom in the ring thereof may be optionally quaternated. More preferably, the heterocyclic group has from 2 to 24 carbon atoms. For example, it includes 4-pyridyl, 2-pyridyl, 1-octylpyridinium-4-yl, 2-pyrimidyl, 2-imidazolyl and 2-thiazolyl groups, etc.

4. Alkoxy Group:

More preferably, the alkoxy group has from 1 to 24 carbon atoms. For example, it includes methoxy, ethoxy, butoxy, octyloxy, methoxyethoxy, methoxypenta(ethyloxy), acryloyloxyethoxy and pentafluoropropoxy groups, etc.

5. Acyloxy Group:

More preferably, the acyloxy group has from 1 to 24 carbon atoms. For example, it includes acetyloxy and benzoyloxy groups, etc.

6. Alkoxycarbonyl Group:

More preferably, the alkoxycarbonyl group has from 2 to 24 carbon atoms. For example, it includes methoxycarbonyl and ethoxycarbonyl groups, etc.

7. Cyano Group:

8. Fluoro Group:

9. Alkoxycarbonyl Group:

10. Cyano Group:

11. Mercapto Group.

Optionally, these substituents may be further substituted.

M represents a polymerizable group, preferably a group capable of additionally forming a carbon-carbon or carbon-oxygen bond to give a polymer. For example, it includes an ethylenic unsaturated residue-having group (e.g., acryloyl, methacryloyl, vinyl, ethynyl), and a cyclic alkyleneoxide group (e.g., epoxy, oxetanyl). Above all, preferred are acryloyl, methacryloyl and cyclic alkyleneoxide groups, etc.

L₁ represents a linking group that bonds the polymerizable group M and the group —Si(OR₃)ₘ₁(R₁)₃₋ₘ₁. Examples of the linking group are an alkylene group, an alkenylene group, an arylene group, —O—, —S—, —CO—, —NR′— where R′ represents a hydrogen atom or an alkyl group, —SO₂—, and a linking group of combinations of two or more of them, etc. Preferably, L₁ is an alkylene group, an arylene group, —O—, and a linking group of a combination of at least two of them. m1 is preferably an integer of from 2 to 3; and n1 is preferably 1.

Specific examples of the compounds represented by the formula (3) are mentioned below, to which, however, the invention is not limited.

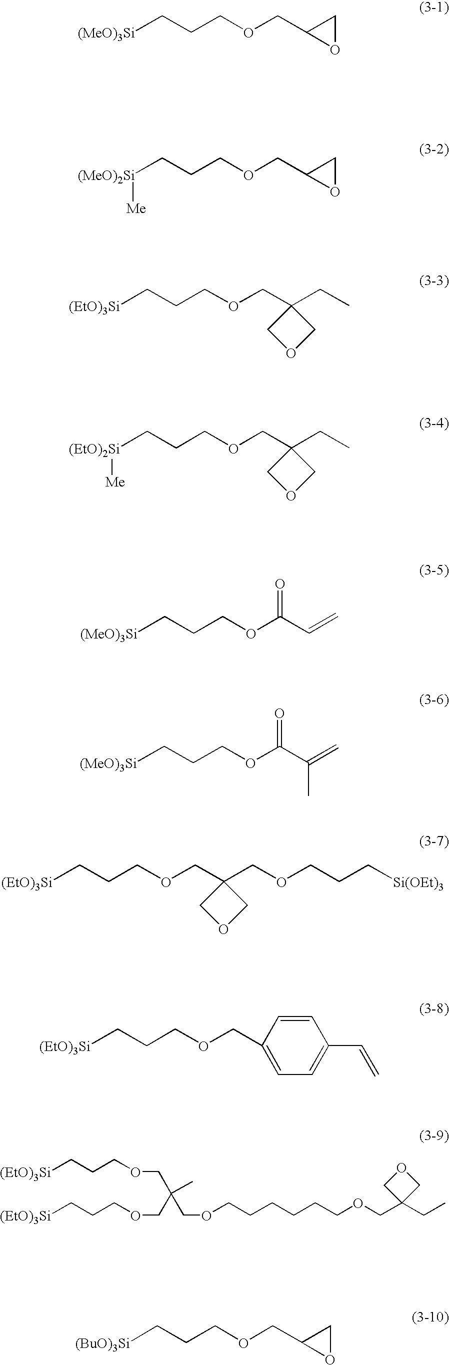

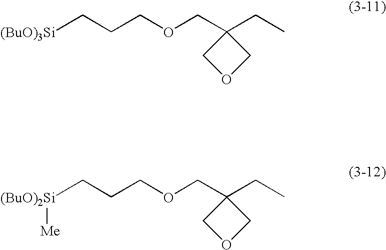

R₁, L₁, m1 and n1 in the formula (1) have the same meanings as those in the formula (3), and their preferred ranges are also the same in the two.

[1-2] Proton-donating Group-having Precursor:

In the proton-conductive membrane of the invention, a group that contains the proton-donating group A in the partial structure represented by the formula (2) is covalent-bonded to the silicon-oxygen three-dimensional crosslinked matrix. The partial structure represented by the formula (2) that contains the proton-donating group A may be formed through sol-gel reaction of a silicon compound as a precursor represented by the formula (4):

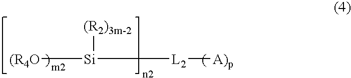

In the formula (4), R₂, R₄, m2 and n2 have the same meanings as R₁, R₃, L₁, m1 and n1, respectively, in the formula (3), and their preferred ranges are also the same in the two. Preferably, the proton-donating group A is an acid residue having a pKa of at most 4. For example, it includes —SO₃H, —P(O) (OH), —OP(O) (OH)₂, and —COOH, etc. Especially preferably, the proton-donating group A is —SO₃H having a low pKa. p indicates an integer of from 1 to 3.

L₂ represents an (n2+p)-valent linking group, and is a linking group which bonds the proton-donating group A and the group —Si(OR₄)ₘ₂(R₂)₃₋ₘ₂. Examples of the linking group are an alkylene group, an alkenylene group, an arylene group, —O—, —S—, —CO—, —NR′— where R′ represents a hydrogen atom or an alkyl group, —SO₂—, and a linking group of combinations of two or more of them, etc. Preferably, the linking group represented by L₂ is an alkylene group, an arylene group, and a linking group of a combination of two or more of them. Especially preferably, it is a propylene group, a methylene group and a phenylene group. m2 is preferably an integer of 2 or 3; and n2 is preferably 1. R₂, L₂, m2, n2, A and p in the formula (2) have the same meanings as those in the formula (4), and their preferred ranges are also the same in the two.

The precursor represented by the formula (4) readily condenses and gels because of its own acid. For it, therefore, it is desirable that a precursor sol prepared by oxidizing a solution of a compound having a mercapto group or a group —(S)ᵣ— where r indicates an integer of from 2 to 5 therein represented by the formula (5) and/or formula (6) is used in forming the proton-conductive membrane of the invention. The group SH and the group —(S)ᵣ—are groups which can be oxidized with an oxidizing agent to be converted into a sulfo group. For the oxidizing agent for the reaction, usable are oxidizing agents capable of oxidizing sulfur compounds, described in Lecture of Experimental Chemistry (by Maruzen). Examples of the oxidizing agent are halogen compounds such as iodine, bromine, etc.; organic peracids such as peracetic acid, 3-chloro-perbenzoic acid, monoperphthalic acid, etc.; and hydrogen peroxide, potassium permanganate, etc. Preferably, the oxidizing agent for use herein is the oxidizing agent which is soluble in water, including, for example, hydrogen peroxide and peracetic acid, etc.

R₂, R₄, m2 and n2 in the formulae (5) and (6) have the same meanings as those in the formula (4), and their preferred ranges are also the same in them. Especially preferably, at least one of R₄'s has at least 4 carbon atoms. In the formula (5), L₃ and q have the same meanings as L₂ and p, respectively, in the formula (4), and their preferred ranges are also the same in the two. In the formula (6), L₄ represents an (n2+1)-valent linking group, and its preferred range is the same as the preferred range of L₂ in the formula (4). r indicates an integer of from 2 to 5. Preferred examples of the compounds represented by the formulae (5) and (6) are mentioned below, to which, however, the invention is not limited.

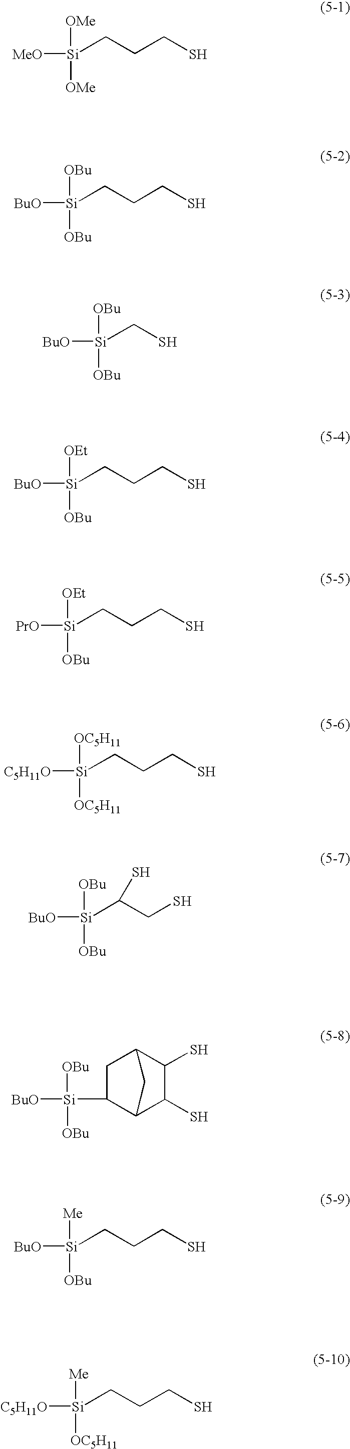

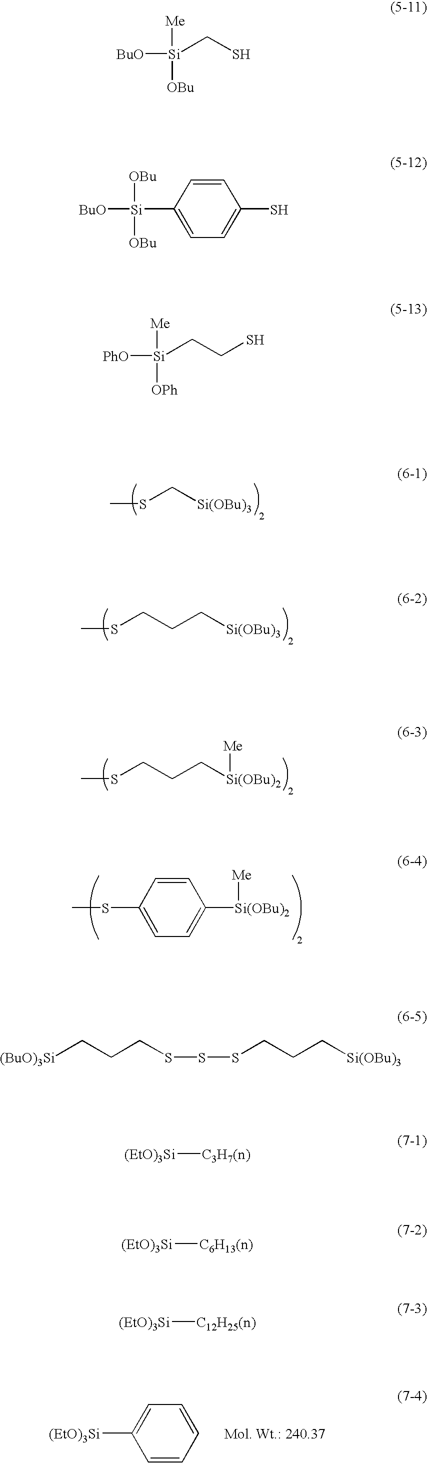

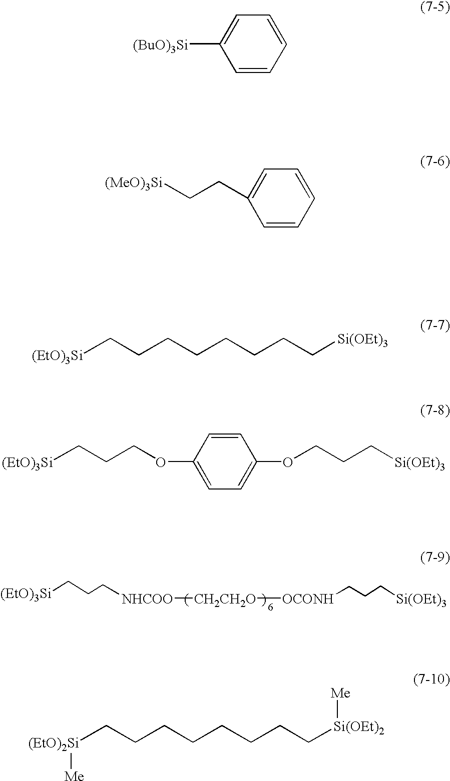

[2] Method of Forming Proton-conductive Membrane:

[2-1] Sol-gel Process:

In the invention, generally employed is a sol-gel process that comprises metal alkoxide hydrolysis, condensation and drying (optionally firing) to give a solid. For example, herein employable are the methods described in JP-A 2000-272932, 2000-256007, 2000-357524, 2001-93543; Japanese Patent 3,103,888 (pp. 4-7); Electrochimica Acta, 1998, Vols. 10-11, No. 43, p. 1301. An acid catalyst is generally used for condensation. However, in the invention where the organosilicon compound as the precursors described in the above [1-1] and [1-2] are used for the reaction, the precursors themselves described in [1-2] may serve as acid catalysts. Therefore, the reaction in invention does not require any additional acid to be added thereto.

One typical method of forming the proton-conductive membrane of the invention comprises dissolving a compound represented by the formula (5) and/or (6) in an arbitrary solvent (e.g., methanol, ethanol, isopropanol, etc.) followed by adding an oxidizing agent thereto to thereby convert the group —SH or the group —(S)ᵣ— in the compound into the group —SO₃H. The resulting sol is mixed with an organosilicon compound described in [1-1] dissolved in an arbitrary organic solvent to effect hydrolysis of the alkoxysilyl group and polycondensation (this is hereinafter referred to as “sol-gel” reaction). Alternatively, a compound of represented by the formula (5) and/or (6) and an organosilicon compound described in [1-1] are dissolved in an arbitrary solvent (e.g., methanol, ethanol, isopropanol), then an oxidizing agent is added thereto to thereby convert the group —SH or—the group (S)ᵣ—in the compound into —SO₃H, and the two are reacted in a mode of sol-gel reaction. If desired, the reaction system may be heated. The viscosity of the reaction mixture (sol) gradually increases, and after the solvent is evaporated away and the remaining sol is dried, then a solid (gel) is obtained. While fluid, the sol may be cast into a desired vessel or applied onto a substrate, and thereafter the solvent is evaporated away and the remaining sol is dried to give a solid membrane. For further densifying the silica network formed therein, the membrane may be optionally further heated after dried.

The solvent for the sol-gel reaction is not specifically defined so far as it dissolves the organosilicon compound as precursors. For it, however, preferred are carbonate compounds (e.g., ethylene carbonate, propylene carbonate, etc.), heterocyclic compounds (e.g., 3-methyl-2-oxazolidinone, N-methylpyrrolidone, etc.), cyclic ethers (e.g., dioxane, tetrahydrofuran, etc.), linear ethers (e.g., diethyl ether, ethylene glycol dialkyl ether, propylene glycol dialkyl ether, polyethylene glycol dialkyl ether, polypropylene glycol dialkyl ether, etc.), alcohols (e.g., methanol, ethanol, isopropanol, ethylene glycol monoalkyl ether, propylene glycol monoalkyl ether, polyethylene glycol monoalkyl ether, polypropylene glycol monoalkyl ether, etc.), polyalcohols (e.g., ethylene glycol, propylene glycol, polyethylene glycol, polypropylene glycol, glycerin, etc.), nitrile compounds (e.g., acetonitrile, glutarodinitrile, methoxyacetonitrile, propionitrile, benzonitrile, etc.), esters (e.g., carboxylates, phosphates, phosphonates, etc.), aprotic polar substances (e.g., dimethylsulfoxide, sulforane, dimethylformamide, dimethylacetamide, etc.), non-polar solvents (e.g., toluene, xylene, etc.), chlorine-containing solvents (e.g., methylene chloride, ethylene chloride, etc.), water, etc. Above all, especially preferred are alcohols such as ethanol, isopropanol, fluoroalcohols, etc.; nitrile compounds such as acetonitrile, glutarodinitrile, methoxyacetonitrile, propionitrile, benzonitrile, etc.; and cyclic ethers such as dioxane, tetrahydrofuran, etc., etc. One or more of these may be used herein either singly or as combined.

For controlling the drying speed, a solvent having a boiling point of not lower than 100° C., such as N-methylpyrrolidone, dimethylacetamide, sulforane or dioxane may be added to the above-mentioned solvent. The total amount of the solvent is preferably from 0.1 to 100 g, more preferably from 1 to 10 g, relative to 1 g of the precursor compounds.

For promoting the sol-gel reaction, an acid catalyst may be used. Preferably, the acid catalyst is an inorganic or organic proton acid. The inorganic proton acid includes, for example, hydrochloric acid, sulfuric acid, phosphoric acids (e.g., H₃PO₄, H₃PO₃, H₄P₂O₇, H₅P₃O₁₀, metaphosphoric acid, hexafluorophosphoric acid, etc.), boric acid, nitric acid, perchloric acid, tetrafluoroboric acid, hexafluoroarsenic acid, hydrobromic acid, solid acids (e.g., tungstophosphoric acid, tungsten-peroxo complex, etc.). For the organic proton acid, for example, usable are low-molecular compounds such as phosphates (for example, phosphates with from 1 to 30 carbon atoms, such as methyl phosphate, propyl phosphate, dodecyl phosphate, phenyl phosphate, dimethyl phosphate, didodecyl phosphate, etc.), phosphites (for example, phosphites with from 1 to 30 carbon atoms, such as methyl phosphite, dodecyl phosphite, diethyl phosphite, diisopropyl phosphite, didodecyl phosphite, etc.), sulfonic acids (for example, sulfonic acids with from 1 to 15 carbon atoms, such as benzenesulfonic acid, toluenesulfonic acid, hexafluorobenzenesulfonic acid, trifluoromethanesulfonic acid, dodecylsulfonic acid, etc.), carboxylic acids (for example, carboxylic acids with from 1 to 15 carbon atoms, such as acetic acid, trifluoroacetic acid, benzoic acid, substituted benzoic acids, etc.), imides (e.g., bis(trifluoromethanesulfonyl)imido acid, trifluoromethanesulfonyltrifluoroacetamide, etc.), phosphonic acids (for example, phosphonic acids with from 1 to 30 carbon atoms, such as methylphosphonic acid, ethylphosphonic acid, phenylphosphonic acid, diphenylphosphonic acid, 1,5-naphthalenebisphosphonic acid, etc.), etc.; or proton acid segment-having high-molecular compounds, for example, perfluorocarbonsulfonic acid polymers such as typically Nafion®, poly(meth)acrylates having a phosphoric acid group in side branches (JP-A 2001-114834), and sulfonated, heat-resistant aromatic polymers such as sulfonated polyether-ether ketones (JP-A 6-93111), sulfonated polyether sulfones (JP-A 10-45913), sulfonated polysulfones (JP-A 9-245818), etc. Two or more of these may be used herein, as combined.

The reaction temperature in the sol-gel reaction is associated with the reaction speed, and it may be suitably selected depending on the reactivity of the precursors to be reacted and on the type of the acid and its amount used. Preferably, it falls between −20 and 150° C., more preferably between 0 and 80° C., even more preferably between 20 and 60° C.

[2-2] Polymerization of Polymerizable Group M:

When the polymerizable group M is an ethylenic unsaturated residue, such as, a (meth) acryloyl, vinyl or ethynyl group, then radical polymerization method of an ordinary polymer production may apply to the case. The process is described in Takayuki Ohtsu & Masaetsu Kinoshita, Experimental Process for Polymer Production (by Kagaku Dojin), and Takayuki Ohtsu, Lecture of Polymerization Theory 1, Radical Polymerization (1) (by Kagaku Dojin). As for the radical polymerization method thermal polymerization method with a thermal polymerization initiator and photopolymerization method with a photopolymerization initiator can be used. Preferred examples of the thermal polymerization initiator are azo-type initiators such as 2,2′-azobis(isobutyronitrile), 2,2′-azobis(2,4-dimethylvaleronitrile), dimethyl 2,2′-azobis(2-methylpropionate), etc.; and peroxide-type initiators such as benzoyl peroxide, etc., etc. Preferred examples of the photopolymerization initiator are α-carbonyl compounds (U.S. Pat. Nos. 2,367,661 and 2,367,670), acyloin ethers (U.S. Pat. No. 2,448,828), α-hydrocarbon-substituted aromatic acyloin compounds (U.S. Pat. No. 2,722,512), polynuclear quinone compounds (U.S. Pat. Nos. 3,046,127 and 2,951,758), combinations of triarylimidazole dimer and p-aminophenyl ketone (U.S. Pat. No. 3,549,367), acridine and phenazine compounds (JP-A 60-105667, U.S. Pat. No. 4,239,850), and oxadiazole compounds (U.S. Pat. No. 4,212,970), etc.

The polymerization initiator may be added to the reaction system before the start of the sol-gel reaction in the above [2-1], or may be added to the reaction product after the sol-gel reaction and immediately before the application of the reaction product to substrates. Preferably, the amount of the polymerization initiator to be added is from 0.01 to 20% by mass, more preferably from 0.1 to 10% by mass relative to the total amount of the monomers.

When the polymerizable group represented by M is a cyclic alkylene oxide group such as an epoxy group or oxetanyl group, then the polymerization catalyst to be used in the case may be a proton acid (proton acid cited in the above [2-1]), or a Lewis acid (preferably, boron trifluoride (including its ether complex), zinc chloride, aluminium chloride, etc.). In case where the proton acid used in the sol-gel reaction serves also as the proton acid, then it does not require any additional proton acid specifically for the polymerization of the polymerizable group M. When used, the polymerization catalyst is preferably added to the reaction product just before the product is applied to substrates. In general, after the application the polymerization is promoted in the membrane being formed on substrates through exposure of the membrane to heat or light.

[2-3] Combination with other Silicon Compound:

If desired, two or more precursors described in the above [1-1] and [1-2] may be mixed for use herein for improving the membrane properties of the materials. For example, precursors represented by the formula (3) where m1 is 3 and 2 are mixed, or precursors represented by the formula (4) where m2 is 3 and 2 are mixed, or these are combined to form more flexible membranes. Optionally, any other silicon compound may be further added to these precursors. Examples of the additional silicon compound are organosilicon compounds represented by the following formula (7), and their polymers.

(R₅)ₘ₃Si—(OR₆)₄₋ₘ₃ (7)

wherein R₅ represents a substituted or unsubstituted alkyl, aryl or heterocyclic group; R₆ represents a hydrogen atom, an alkyl group, an aryl group, or a silyl group; m3 represents an integer of from 0 to 4; when m3 or (4-m3) is 2 or more, then R₅'s or R₆'s may be the same or different respectively; and R₅ or the substituent of R₅ may bond to any other to form a polymer.

In the formula (7), m3 is preferably 0 or 1, and R₆ is preferably an alkyl group. Examples of preferred compounds where m3 is 0 are tetramethoxysilane (TMOS) and tetraethoxysilane (TEOS), etc. Examples of preferred compounds where m3 is 1 or 2 are the compounds mentioned below.

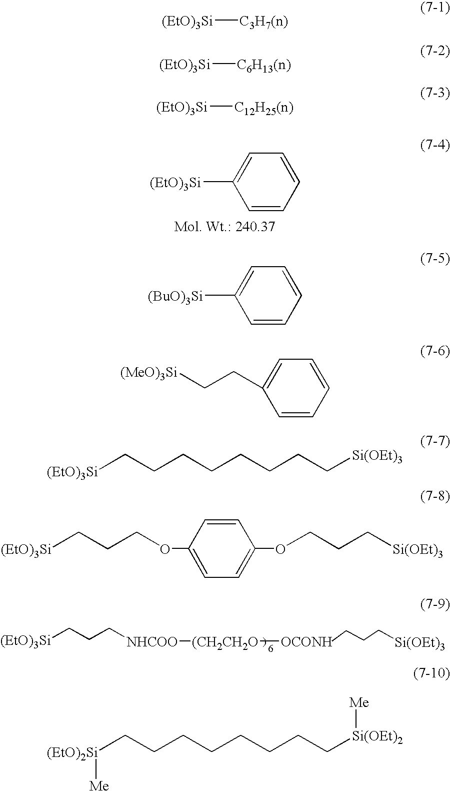

When the compound represented by the formula (7) is combined with the organosilicon compound as the precursors, then its amount is preferably in the range of from 1 to 50 mol %, more preferably in the range of from 1 to 20 mol % of the precursors.

The supports to which the sol-gel reaction mixture is applied in the invention are not specifically defined, and their preferred examples are glass substrates, metal substrates, polymer films and reflectors, etc. Examples of the polymer films are cellulose polymer films such as TAC (triacetyl cellulose), ester polymer films such as PET (polyethylene terephthalate) or PEN (polyethylene naphthalate), fluoropolymer films such as PTFE (polytrifluoroethylene), and polyimide films, etc. Any known method of, for example, curtain coating, extrusion coating, roll coating, spin coating, dipping, bar coating, spraying, slide coating or printing, etc. is herein employable for applying the sol-gel reaction mixture to the supports.

The thickness of the organic-inorganic hybrid proton-conductive membrane thus obtained by peeling it from a support is preferably from 10 to 500 μm, especially preferably from 25 to 100 μm.

[3] Fuel Cell:

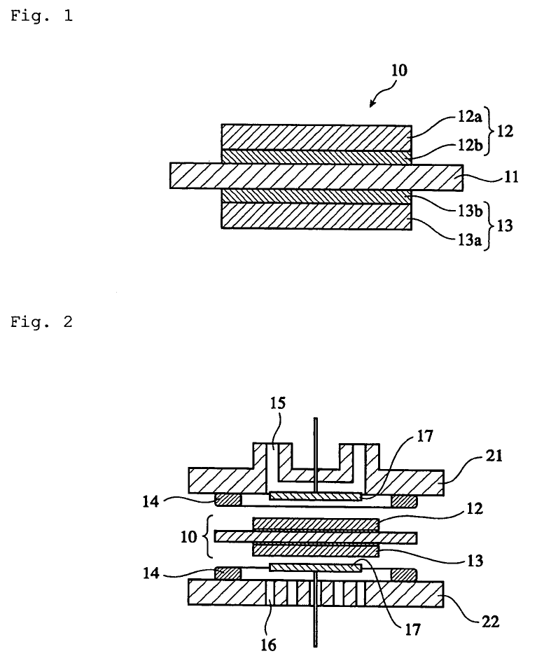

A fuel cell is described, which comprises the organic-inorganic hybrid proton-conductive membrane of the invention. FIG. 1 shows the constitution of a membrane electrode assembly (hereinafter referred to as “MEA”) 10. The MEA 10 comprises a proton-conductive membrane 11, and an anode 12 and a cathode 13 that are opposite to each other via the membrane 11.

The anode 12 and the cathode 13 each comprise a porous conductive sheet (e.g., carbon paper) 12a, 13a, and a catalyst layer 12b, 13b. The catalyst layer 12b, 13b is formed of a dispersion of carbon particles (e.g., ketjen black, acetylene black, carbon nanotube, etc.) that carry a catalyst metal such as platinum particles, etc. thereon, in a proton-conductive material (e.g., Nafion, etc.). For airtightly adhering the catalyst layers 12b, 13b to the proton-conductive membrane 11, generally employed is a method of hot-pressing the porous conductive sheets 12a, 13a each coated with the catalyst layer 12b, 13b, against the proton-conductive membrane 11 (preferably at 120 to 130° C. under 2 to 100 kg/cm²); or a method of pressing the catalyst layers 12b, 13b each coated on a suitable support, against the proton-conductive membrane 11 while transferring the layers onto the membrane, followed by making the resulting laminate structure sandwiched between the porous conductive sheets 12a, 13a.

FIG. 2 shows one example of a single fuel cell. The fuel cell comprises the MEA 10, a pair of separators 21, 22 between which the MEA 10 is sandwiched, and a collector 17 of a stainless net and a gasket 14 both fitted to the separators 21, 22. The anode-side separator 21 has an anode-side opening 15 formed through it; and the cathode-side separator 22 has a cathode-side opening 16 formed through it. Vapor fuel such as hydrogen or alcohol (e.g., methanol) or liquid fuel such as aqueous alcohol solution, etc. is fed to the cell via the anode-side opening 15; and an oxidizing gas such as oxygen gas or air is fed via the cathode-side opening 16.

The invention is described in more detail with reference to the following Examples, to which, however, the invention is not limited.

### EXAMPLE 1

1. Formation of Proton-conductive Membranes:

Proton-conductive membranes E-1 to E-7 of the invention and a comparative proton-conductive membrane R-1 were formed according to the method mentioned below.

(1) Formation of Proton-conductive Membrane E-1:

1.61 g of compound (5-2) was dissolved in 4.8 g of methanol, to which was added 2.6 g of aqueous 30% hydrogen peroxide. The resulting mixture was stirred at room temperature for 24 hours and then subjected to NMR, which confirmed the absence of —SH group and the presence of —SO₃H group in the thus-processed compound (5-2). Thus prepared, the sol (SOL-1) was colorless transparent, and was stable for 10 days while kept in a cold and dark place (5° C.).

Next, 1.5 g of SOL-1 and 0.2 ml of xylene were added to a solution of 0.2 g of precursor (3-1) in 0.6 ml of 2,2,3,3-tetrafluoro-1-propanol, and stirred under heat at 50° C. for 3 hours. The resulting mixture was cast over a polyimide film (Upilex-75S manufactured by Ube Kosan), and dried at room temperature for 24 hours. Thus solidified, this was peeled away from the polyimide film to obtain a white membrane having a thickness of 120 μm.

(2) Formation of Proton-conductive Membrane E-2:

1.2 g of SOL-1 and 0.2 ml of xylene were added to a solution of 0.2 g of precursor (3-3) in 0.6 ml of 2,2,3,3-tetrafluoro-1-propanol, and stirred under heat at 50° C. for 3 hours. The resulting mixture was cast over a polyimide film (Upilex-75S manufactured by Ube Kosan), and dried at room temperature for 24 hours. Thus solidified, this was peeled away from the polyimide film to obtain a white membrane having a thickness of 110 μm.

(3) Formation of Proton-conductive Membrane E-3:

0.2 g of precursor (3-3) and 0.2 g of compound (5-2) were dissolved in 1.5 g of isopropyl alcohol, 0.6 ml of 2,2,3,3-tetrafluoro-1-propanol and 0.2 ml of xylene, to which was added 0.33 g of aqueous 30% hydrogen peroxide. The resulting mixture was stirred at room temperature for 24 hours and then stirred under heat at 50° C. for 3 hours. The resulting mixture this was cast over a polyimide film (Upilex-75S manufactured by Ube Kosan), and dried at room temperature for 24 hours. Thus solidified, this was peeled away from the polyimide film to obtain a white membrane having a thickness of 120 μm.

(4) Formation of Proton-conductive Membrane E-4:

1.2 g of SOL-1 and 0.2 ml of xylene were added to a solution of 0.11 g of precursor (3-3) and 0.09 g of precursor (3-4) and 0.6 ml of 2,2,3,3-tetrafluoro-1-propanol, and stirred under heat at 50° C. for 5 hours. The resulting mixture was cast over a polyimide film (Upilex-75S manufactured by Ube Kosan), and dried at room temperature for 24 hours. Thus solidified, this was peeled away from the polyimide film to obtain a white membrane having a thickness of 110 μm.

(5) Formation of Proton-conductive Membrane E-5:

1.2 g of SOL-1 and 0.2 ml of xylene were added to a solution of 0.25 g of precursor (3-11) and 0.6 ml of 2,2,3,3-tetrafluoro-1-propanol, and stirred under heat at 50° C. for 5 hours. The resulting mixture was cast over a polyimide film (Upilex-75S manufactured by Ube Kosan), and dried at room temperature for 24 hours. Thus solidified, this was peeled away from the polyimide film to obtain a white membrane having a thickness of 100 μm.

(6) Formation of Proton-conductive Membrane E-6:

1.47 g of compound (5-3) was dissolved in 4.4 g of methanol, to which was added 2.55 g of aqueous 30% hydrogen peroxide. The resulting mixture was stirred at room temperature for 24 hours and then subjected to NMR, which confirmed the absence of —SH group and the presence of —SO₃H group in the thus-processed compound (5-3). Thus prepared, the sol (SOL-2) was colorless transparent, and was stable for 5 days while kept in a cold and dark place (5° C.).

Next, 0.9 g of SOL-2 and 0.2 ml of xylene were added to a solution of 0.2 g of precursor (3-11) and 0.6 ml of 2,2,3,3-tetrafluoro-1-propanol, and stirred under heat at 50° C. for 3 hours. The resulting mixture was cast over a polyimide film (Upilex-75S manufactured by Ube Kosan), and dried at room temperature for 24 hours. Thus solidified, this was peeled away from the polyimide film to obtain a white membrane having a thickness of 130 μm.

(7) Formation of Proton-conductive Membrane E-7:

0.54 g of compound (5-2) and 1.32 g of compound (5-9) were dissolved in 5.6 g of methanol, to which was added 3.5 g of aqueous 30% hydrogen peroxide. The resulting mixture was stirred at room temperature for 24 hours and then subjected to NMR, which confirmed the absence of —SH group and the presence of —SO₃H group in the thus-processed compound (5-2) and compound (5-9). Thus prepared, the sol (SOL-3) was colorless transparent, and was stable for 7 days while kept in a cold and dark place (5° C.).

Next, 1.1 g of SOL-3 and 0.2 ml of xylene were added to a solution of 0.27 g of precursor (3-11) and 0.6 ml of 2,2,3,3-tetrafluoro-1-propanol, and stirred under heat at 50° C. for 3 hours. The resulting mixture was cast over a polyimide film (Upilex-75S manufactured by Ube Kosan), and dried at room temperature for 24 hours. Thus solidified, this was peeled away from the polyimide film to obtain a white membrane having a thickness of 120 μm.

(8) Formation of Proton-conductive Membrane R-1:

0.23 g of precursor (3-1) and 0.1 g of TEOS were dissolved in ethanol, to which was added 50 μl of an aqueous 2% hydrochloric acid solution at 25° C. and stirred for 20 minutes. To this was further added an isopropanol solution of phosphoric acid (85% phosphoric acid (H₃PO₄, 167 mg)/isopropanol (1 ml)), and stirred at 25° C. for 30 minutes. The resulting mixture was applied onto a Teflon sheet, using an applicator. This was left as such at room temperature for 2 hours, and then heated at 50° C. for 2 hours and further at 80° C. for 3 hours. Next, this was peeled away from the Teflon sheet to obtain a transparent solid sheet R-1 having a thickness of 100 μm.

2. Resistance to Aqueous Methanol Solution:

Circular discs having a diameter of 13 mm were blanked out of the thus-obtained proton-conductive membranes (E-1 to E-7, R-1) and Nafion 117, and each of these samples was dipped in 5 ml of an aqueous 10 mas. % methanol solution for 48 hours. The proton-conductive membranes (E-1 to E-7) of the invention swelled little, and their shape and strength did not change from those of the non-dipped samples. Contrary to this, the comparative sample R-1 cracked. In addition, this dissloved 85% by mass of the theoretical amount of phosphoric acid into the aqueous methanol solution. The Nafion 117 swelled by about 70% by mass, and its shape changed. These results confirm that the proton-conductive membranes of the invention are satisfactorily resistant to the fuel, aqueous methanol solution used in direct methanol fuel cells.

3. Ionic Conductivity and Membrane Flexibility:

Circular discs having a diameter of 13 mm were blanked out of the proton-conductive membranes (E-1 to E-7, R-1) and Nafion 117. Sandwiched between two stainless plates, the ionic conductivity of each of these samples was measured at 25° C. and at a relative humidity of 95% according to an AC impedance process. In addition, the membrane flexibility of each sample was qualitatively evalated according to a folding test. The results are given in Table 1.

TABLE 1

| Proton-Conductive | Ionic Conductivity × | Qualitative Evaluation | |
|---|---|---|---|
| Membrane | 10⁻³ S/cm | of Membrane (*1) | Reamarks |
| E-1 | 0.22 | ◯ | invention |
| E-2 | 0.28 | ◯ | invention |
| E-3 | 0.36 | ⊚ | invention |
| E-4 | 0.26 | ⊚ | invention |
| E-5 | 0.29 | ◯ | invention |
| E-6 | 0.25 | ◯ | invention |
| E-7 | 0.27 | ⊚ | invention |
| R-1 | 0.12 | Δ | comparative |
| Nafion 117 | 6.20 | ⊚ | comparative |

(*1)
⊚: The membrane is flexible.
◯: The membrane is flexible but is relatively readily cracked.
Δ: The membrane is relatively but is readily cracked.

(Conclusion)

The proton-conductive membranes (E-1 to E-7) of the invention are more flexible and have a higher ionic conductivity than the comparative membrane (R-1).

### EXAMPLE 2

1. Formation of Catalyst Membrane:

2 g of platinum-carrying carbon (Vulcan XC72 carrying 50 wt. % platinum) was mixed with 15 g of a Nafion solution (5% alcoholic aqueous solution), and dispersed for 30 minutes with an ultrasonic disperser. The mean particle size of the resulting dispersion was about 500 nm. The resulting dispersion was applied onto carbon paper (having a thickness of 350 μm) and dried, and a circular disc having a diameter of 9 mm was blanked out of it.

2. Fabrication of MEA:

The catalyst membrane prepared in 1 was attached to both surfaces of the proton-conductive membrane (E-1, E-3, E-4, E-5, E-7) formed in Example 1 and Nafion 117 in such a manner that the dispersion-coated face of the catalyst membrane could be contacted with the proton-conductive membrane, and hot-pressed at 120° C. and under 50 kg/cm² to fabricate MEA-1 to MEA-6.

3. Fuel Cell Properties:

The MEA fabricated in 2 was set in a fuel cell as in FIG. 2, and an aqueous 50 mas. % methanol solution was filled into the cell via the anode-side opening 15. In this condition, the cathode-side opening 16 was kept in contact with air. Using a galvanostat, a constant current of 5 mA/cm² was applied to the cell, and the cell voltage was measured in this stage. The results are given in Table 2.

TABLE 2

| | | | Time-Dependent Change of | | | |
|---|---|---|---|---|---|---|
| Proton- | | | Terminal Voltage (V) | | | |
| Conductive | | Cell | | after 0.5 | | |
| Membrane | MEA | C | initial | hrs | after 1 hr | Remarks |
| E-1 | 1 | 1 | 0.57 | 0.55 | 0.53 | invention |
| E-3 | 2 | 2 | 0.59 | 0.57 | 0.56 | invention |
| E-4 | 3 | 3 | 0.56 | 0.54 | 0.52 | invention |
| E-5 | 4 | 4 | 0.58 | 0.56 | 0.55 | invention |
| E-7 | 5 | 5 | 0.57 | 0.55 | 0.53 | invention |
| Nafion 117 | 6 | 6 | 0.66 | 0.45 | 0.37 | comparative |

(Conclusion)

The initial voltage of the cell C-6 having MEA-6 with a Nafion membrane therein was high, but the voltage of the cell decreased in time. The time-dependent voltage depression in the cell is caused by the so-called methanol-crossover phenomenon, or that is, by the leakage of the fuel, methanol applied to the side of the anode 12 through the Nafion membrane toward the side of the cathode 13. Contrary to this, the voltage in the cells C-1 to C-5 having MEA-1 to MEA-5, respectively, with the proton-conductive membrane of the invention therein was stable, and it is understood that these cells can maintain a higher voltage than the cell C-6 having a Nafion membrane therein.

As in the above, the organic-inorganic hybrid proton-conductive membrane of the invention is flexible and the dissolution of the proton donor from it is small. In addition, its ionic conductivity at room temperature is high, and its resistance to aqueous methanol solution is high to reduce methanol crossover in cells. Accordingly, when the proton-conductive membrane of the invention is used in direct methanol fuel cells, it enables higher output power from the cells than conventional proton-conductive membranes.

The present disclosure relates to the subject matter contained in Japanese Patent Application No. 082371/2003 filed Mar. 25, 2003, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A proton-conductive membrane having a structure with a group that contains an organic molecular chain and a proton-donating group being covalent-bonded to a silicon-oxygen three-dimensional crosslinked matrix therein, which contains a partial structure represented by the following formula (1): 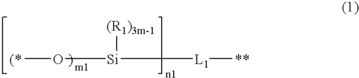
wherein R₁ represents an alkyl group or an aryl group; L₁ represents an (n1+1)-valent linking group; m1 represents an integer of from 1 to 3; n1 represents an integer of from 1 to 4; * indicates the position at which the groupbonds to the silicon atom; and ** indicates the position at which the group bonds to an organic polymer chain,
and a partial structure represented by the following formula (2): 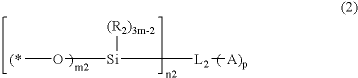
wherein R₂ represents an alkyl group or an aryl group; L₂ represents an (n2+p)-valent linking group; A represents a proton-donating group; m2 represents an integer of from 1 to 3; n2 represents an integer of from 1 to 4; p represents an integer of from 1 to 3; * indicates the position at which the group bonds to the silicon atom.

2. The proton-conductive membrane of claim 1, wherein R₁ in the formula (1) is an alkyl group having from 1 to 10 carbon atoms.

3. The proton-conductive membrane of claim 1, wherein L₁ in the formula (1) represents an alkylene group, an arylene group, —O—, or a linking group formed by combining two or more thereof.

4. The proton-conductive membrane of claim 1, wherein m1 in the formula (1) is 2 or 3.

5. The proton-conductive membrane of claim 1, wherein n1 in the formula (1) is 1.

6. The proton-conductive membrane of claim 1, wherein R₂ in the formula (2) is an alkyl group having from 1 to 10 carbon atoms.

7. The proton-conductive membrane of claim 1, wherein L₂ in the formula (2) is an alkylene group, an arylene group, or a linking group formed by combining two or more thereof.

8. The proton-conductive membrane of claim 1, wherein m2 in the formula (2) is 2 or 3.

9. The proton-conductive membrane of claim 1, wherein n2 in the formula (2) is 1.

10. The proton-conductive membrane of claim 1, wherein the partial structure represented by the formula (1) is formed through sol-gel reaction of an organosilicon compound as a precursor represented by the following formula (3): 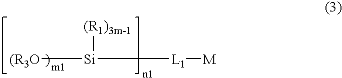
wherein R₁ represents an alkyl group or an aryl group; R₃ represents a hydrogen atom, an alkyl group, an aryl group or a silyl group; L₁ represents an (n1+1)-valent linking group; M represents a polymerizable group that may form a carbon-carbon bond or a carbon-oxygen bond through polymerization; m1 represents an integer of from 1 to 3; n1 represents an integer of from 1 to 4; and when m1 is 2 or more, then R₃'s may be the same or different.

11. The proton-conductive membrane of claim 10, wherein R₃ in the formula (3) is an alkyl group having from 1 to 10 carbon atoms.

12. The proton-conductive membrane of claim 10, wherein M in the formula (3) is an ethylenic unsaturated residue, an epoxy group, or an oxetanyl group.

13. The proton-conductive membrane of claim 1, wherein the partial structure represented by the formula (2) is formed through sol-gel reaction of an organosilicon compound as a precursor represented by the following formula (4): 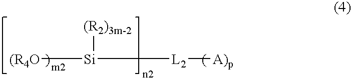
wherein R₂ represents an alkyl group or an aryl group; R₄ represents a hydrogen atom, an alkyl group, an aryl group or a silyl group; L₂ represents an (n2+p)-valent linking group; A represents a proton-donating group; m2 represents an integer of from 1 to 3; n2 represents an integer of from 1 to 4; p represents an integer of from 1 to 3; and when m2 is 2 or more, then R₄'s may be the same or different.

14. The proton-conductive membrane of claim 13, wherein R₄ in the formula (4) is an alkyl group having from 1 to 10 carbon atoms.

15. The proton-conductive membrane of claim 13, wherein the precursor represented by the formula (4) is a sulfonic acid sol prepared through oxidation of a solution that contains an organosilicon compound represented by the following formula (5) 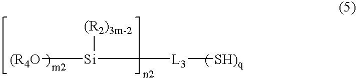
wherein R₂ represents an alkyl group or an aryl group; R₄ represents a hydrogen atom, an alkyl group, an aryl group or a silyl group; L₃ represents an (n2+q)-valent linking group; m2 represents an integer of from 1 to 3; n2 represents an integer of from 1 to 4; q represents an integer of from 1 to 3; and when m2 is 2 or more, then R₄'s may be the same or different.

16. The proton-conductive membrane of claim 13, wherein the precursor represented by the formula (4) is a sulfonic acid sol prepared through oxidation of a solution that contains an organosilicon compound represented by the following formula (6) 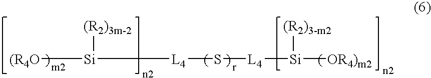
wherein R₂ represents an alkyl group or an aryl group; R₄ represents a hydrogen atom, an alkyl group, an aryl group or a silyl group; L₄ represents an (n2+1)-valent linking group; m2 represents an integer of from 1 to 3; n2 represents an integer of from 1 to 4; r represents an integer of from 2 to 5; and when m2 is 2 or more, then R₄'s may be the same or different.

17. The proton-conductive membrane of claim 10, which is formed through sol-gel reaction of a sulfonic acid sol and an organosilicon compound represented by the formula (3) wherein the sulfonic acid sol is prepared through oxidation with an oxidizing agent of a solution that contains an organosilicon compound represented by the following formula (5) and/or formula (6): 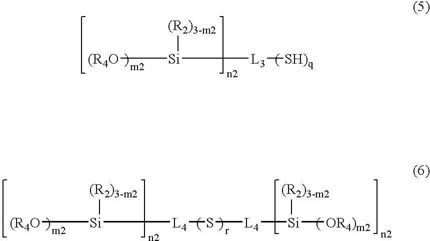
wherein R₂ represents an alkyl group or an aryl group; R₄ represents a hydrogen atom, an alkyl group, an aryl group or a silyl group; L₃ represents an (n2+q)-valent linking group; L₄ represents an (n2+1)-valent linking group; m2 represents an integer of from 1 to 3; n2 represents an integer of from 1 to 4; q represents an integer of from 1 to 3; r represents an integer of from 2 to 5; and when m2 is 2 or more, then R₄'s may be the same or different.

18. The proton-conductive membrane of claim 17, wherein the oxidizing agent is hydrogen peroxide or peracetic acid.

19. A membrane electrode assembly comprising the proton-conductive membrane of claim 1.

20. A fuel cell comprising the proton-conductive membrane of claim 1.
